(19) United States
(12) Patent Application Publication
(10) Pub. No.: US 2015/0172919 A1
(43) Pub. Date: Jun. 18, 2015

(54) PROCESSING SECURE SMS MESSAGES

(71) Applicants: General Motors LLC, Detroit, MI (US); GM Global Technology Operations LLC, Detroit, MI (US)

(72) Inventors: Chaminda Basnayake, Windsor (CA); Dipankar Pal, Sylvania, OH (US); David George, Farmington Hills, MI (US); Thomas M. Forest, Macomb, MI (US)

(73) Assignees: General Motors LLC, Detroit, MI (US); GM Global Technology Operations LLC, Detroit, MI (US)

(21) Appl. No.: 14/105,235

(22) Filed: Dec. 13, 2013

(51) Int. Cl. H04W 12/06; H04W 12/04; H04W 4/14

(52) U.S. Cl. CPC H04W 12/06; H04W 4/14; H04W 12/04

(57) ABSTRACT

A system for processing an SMS message transmitted between a vehicle telematics unit and a call center and a method of processing an SMS message using the system. The method includes the steps of: receiving an SMS message having security data, wherein both a header and a payload of the SMS message carry the security data; attempting to authenticate the security data; accepting the SMS message if the security data is authenticated, and ignoring the contents of the SMS message if the security data is not authenticated.

### TECHNICAL FIELD

The present invention relates to secure telecommunications, and more specifically, to securely processing SMS messages.

### BACKGROUND

Short Message Service (SMS) messages may be generated by a originating mobile device and transmitted to a terminating mobile device via an SMS service center. The service center may stamp the SMS message with a timestamp at the time the SMS message is received prior to retransmitting it to the terminating mobile device. The timestamp may be used by the terminating mobile device to determine whether to accept or ignore the SMS message.

### SUMMARY

According to an embodiment of the invention, there is provided a method of processing an SMS message transmitted between a vehicle telematics unit and a call center. The method includes the steps of: receiving an SMS message having security data, wherein both a header and a payload of the SMS message carry the security data; attempting to authenticate the security data; accepting the SMS message if the first security data is authenticated, and ignoring the contents of the SMS message if the security data is not authenticated.

According to another embodiment of the invention, there is provided a method of processing an SMS message. The method includes: step (a) receiving at a vehicle telematics unit an SMS message having a vehicle instruction, wherein the SMS message includes security data carried by a header of the SMS message, wherein an encrypted version of the security data is also carried by a payload of the SMS message; step (b) determining whether a telematics unit system time is accurate; step (c) when in step (b) the system time is determined to be accurate, evaluating the validity of the security data using the system time, wherein if security data is evaluated to be invalid, compiling an SMS error report and at least omitting the executing step (g); step (d) determining whether a duplicate of the SMS message was previously received at the telematics unit, wherein if a duplicate was previously received, compiling an SMS error report and at least omitting the executing step (g); step (e) decrypting the encrypted version of the security data; step (f) authenticating the security data carried by the header using the decrypted security data, wherein if the security data carried by the header is not authenticated, compiling an SMS error report and omitting step (g); and step (g) if the security data carried by the header is authenticated, executing the vehicle instruction.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a schematic illustration of an SMS message;

FIG. 3 is a timeline illustrating an exchange of an SMS message; and

FIG. 4 is a flowchart illustrating one embodiment of a process of exchanging a secure SMS message.

### DETAILED DESCRIPTION OF THE ILLUSTRATED EMBODIMENT(S)

The methods described below pertain generally to authenticating SMS messages transmitted between a telematics unit of a vehicle and a call center. For example, SMS messages sent from the call center may contain remote vehicle commands such as to open a vehicle door or remote-start the vehicle making them a more likely the target of malicious attacks. For example, during a record and replay attack, an SMS message commanding the door to open may be recorded by the malicious source and later replayed (e.g., when the vehicle user is not nearby), thus allowing the malicious source or a co-conspirator unlawful entry into the vehicle. The authentication described herein includes several security features including, among other things, providing security data within a header and a payload of an SMS message that contains a message (e.g., a vehicle command). One security feature includes an encryption of the security data in the payload. The vehicle telematics unit may decrypt the payload security data and authenticate that it is the same as that carried by the SMS header. Where the security data is authenticated, the message may be accepted, and where the message is a vehicle command, the command may be executed. When the security data is not authenticated, the SMS message may be ignored and the failed authentication may be reported to the call center.

The operating environment of the call center and vehicle will be described first; after which, several implementations of the disclosure and method will be described in greater detail.

### Communications System

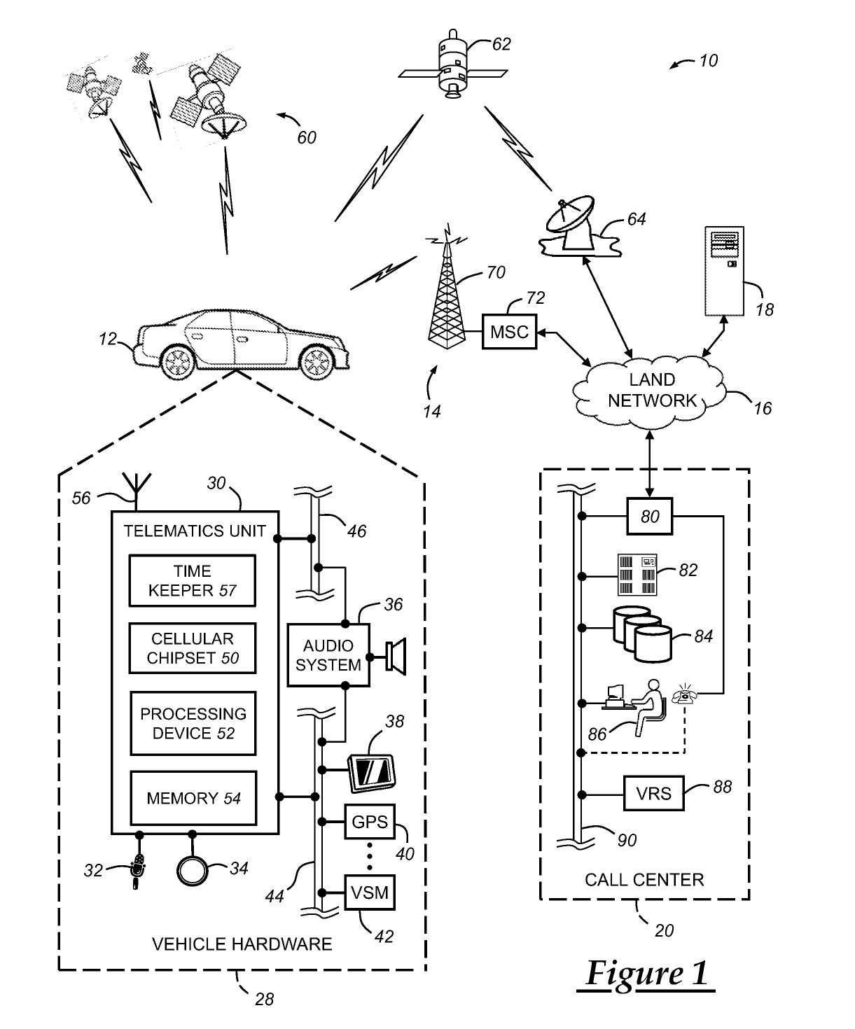

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM (including LTE technologies) or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server. The telematics unit 30 may further include a timekeeper 57 and/or timekeeping software for maintaining a telematics unit system time. The timekeeper may be used to timestamp or otherwise mark or associate the system time with incoming and/or outgoing communications. For example, SMS messaging communicated between the call center 20 and the telematics unit may be timestamped; in addition, the system time may be used to evaluate whether incoming SMS messages have expired. The timekeeper 57 and/or timekeeping features may be implemented in various suitable ways as will be appreciated by skilled artisans.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. GPS should be construed broadly to include global positioning system (GPS) satellites, global navigation satellite systems (GNSS), and any other suitable geographic positioning satellite. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method

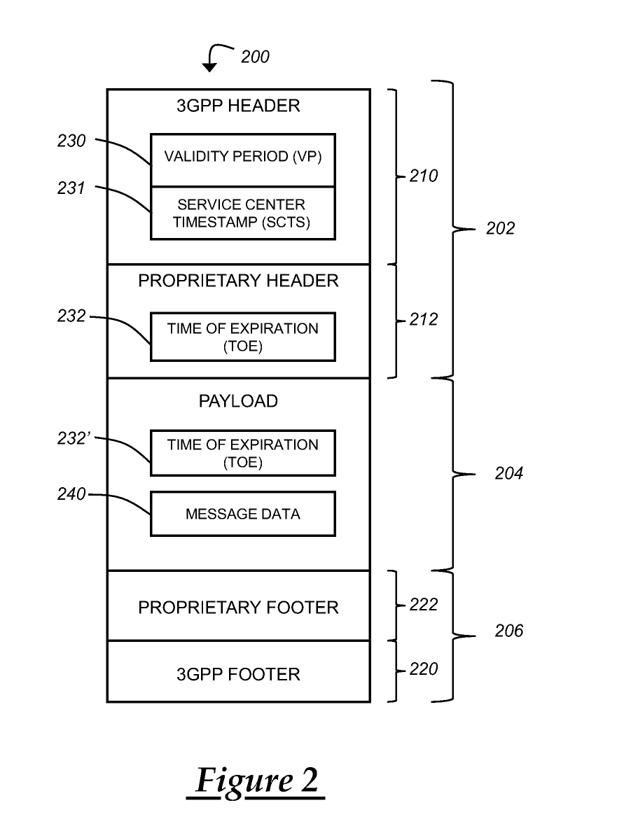

The aforedescribed communications system 10 is illustrative of one operating environment. The system 10 may be used to validate and/or authenticate SMS messages sent between the vehicle 12 and the call center 20. FIGS. 2-5 illustrate the call center 20 sending an SMS message to the vehicle 12; however, this is merely one example. For example, the vehicle 12 could send the SMS message which is then received and authenticated by the call center. Of course, it should be appreciated that other implementations in other environments are also possible.

FIG. 2 illustrates one embodiment of an SMS message 200 that may be transmitted from the call center 20 to the vehicle 12, or more specifically, to the vehicle telematics unit 30. The SMS message 200 is shown having a header portion 202, a payload 204, and a footer portion 206. The header portion 202 of the message 200 may include a standardized header 210 (e.g., a 3GPP header) and a proprietary or call center unique header 212. Similarly, the footer portion 206 may include a standardized footer 220 (e.g., a 3GPP footer) and a proprietary or call center unique footer 222. Of course, other headers and footers also are possible (e.g., non-3GPP standards).

The standardized header 210 and/or the proprietary header 212 may carry or include time-related data such as a validity period (VP) data 230, a SMS Service Center TimeStamp (SCTS) data 231, and security data 232 that includes a time of expiration (TOE) data. The VP data 230 may be a duration of time assigned by the originating mobile device (or call center 20) indicating a period of time in which the message 200 should be delivered (or attempted to be delivered). For example, if the VP is 50 seconds, the SMS Service Center may no longer attempt to deliver the message 200 after 50 seconds of receiving it. The SCTS data 231 may be a time marker indicating when the Service Center received the message 200 (e.g., from the originating mobile device). Regardless, the inclusion of the VP data and SCTS data are known and other aspects and features of the VP data and SCTS data will be appreciated by skilled artisans. In at least one embodiment, the VP data 230 and SCTS data 231 may be carried by the standard header 210 and the security data 232 may be carried by the proprietary header 212.

At least a portion of the security data 232, e.g., the TOE data, may be a predetermined absolute date and time assigned by the originating mobile device in which the SMS message is considered to be expired when received by a terminating mobile device (e.g., the telematics unit 30). The TOE may be set at the time of message origination. As will be explained in greater detail below, the TOE data may be used to validate and/or authenticate that the message 200 has been timely received and/or that tampering has not occurred. One illustrative implementation of TOE data may include the call center 20 assigning the TOE to the message 200 (e.g., creating the proprietary header 212) and the telematics unit determining whether the message 200 has expired using the TOE data and the timekeeper 57. For example, if the call center 20 assigned the TOE to be 30-60 seconds after SMS origination, then the message 200 would be considered expired unless the telematics unit 30 received the message 200 within 30-60 seconds of origination.

Other time-related data also may be carried by the message 200, including a timestamp of mobile origination of the SMS message and various other timestamps or timestamp data accompanying the SMS message (e.g., associated with the creation or generation of the SMS or its delivery or receipt), etc.

FIG. 2 further illustrates that the payload 204 may carry or include message data 240 and security data 232′. Message data 240 may include an informational message for the vehicle or vehicle user or a vehicle command or instruction or any other suitable data for the vehicle and/or user. As used herein, a vehicle user may be a vehicle driver, passenger, etc., and the user does not need to have ownership of the vehicle 12 (e.g., the vehicle user may be an owner or a licensee). The security data 232′ may include an encrypted version of the security data 232 carried in the header portion 202 (i.e., in the proprietary header 212). For example, the call center 20 may perform a hash function on the security data 232 to generate the security data 232′ (e.g., an encrypted version of the TOE data). The encryption may utilize public or private key infrastructure. Regardless, encryption is known to skilled artisans and will not be elaborated further here. The message data 240 and security data 232′ are merely examples of information that may be carried by the payload 204; other information may be carried as well.

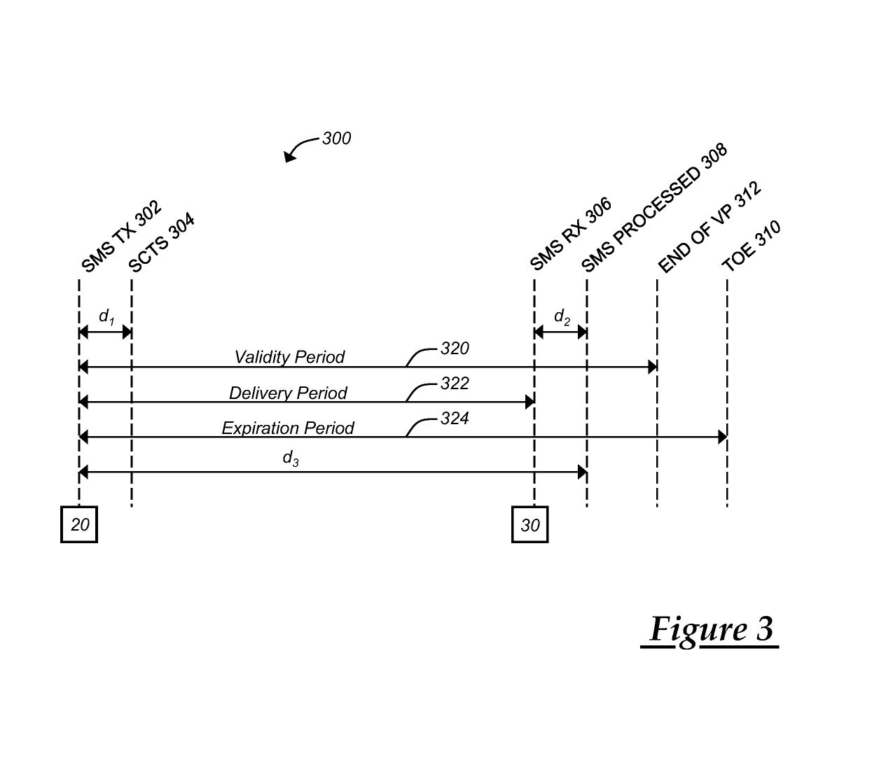

FIG. 3 depicts one embodiment of a life cycle or timeline 300 illustrating an exchange of the SMS message 200 between the call center 20 and the telematics unit 30. The timeline 300 illustrates various moments or points in time during the exchange, as well as various determinable periods of time spanning at least from or to one or more of the depicted points in time. FIG. 3 shows six points in time: a time of SMS message origination transmission (SMS TX) 302, a service center timestamp time (e.g., the SCTS) 304, a time of SMS message receipt or termination (SMS RX) 306, a time of SMS message processed 308, a predetermined time when the SMS message has expired according to the time of expiration or TOE, at point 310 (e.g., assigned by the call center 20 and associated with and derived from the TOE data), and a predetermined period of time when the SMS message has expired according to the validity period (VP), at point 312 (e.g., assigned by the call center and associated with and derived from the VP data). Thus, according to these defined points in time, the SMS message 200 may be originated at the call center 20 at point 302, be received at the service center receiving the SCTS at point 304, be received by the telematics unit 30 at point 306, and be processed by the telematics unit 30 at point 308. Timely delivery of the message 200 may include delivery action prior to the expiration of the VP and the TOE; more specifically, the message 200 is timely if both transmitted by the SMS Service Center prior to the expiration of the message VP and received and/or processed by the telematics unit prior to the expiration of the TOE. In at least one implementation, the period of time associated with the VP is shorter than or equal to the time duration associated with the TOE data; e.g., the call center may set the VP to 60 seconds and the call center may set the TOE to be 60 minutes. The TOE data may provide a validatable and authenticatable security means to avoid executing a vehicle command (such as doors unlock or vehicle start) when the SMS message may be malicious (e.g., a spoofed or replay attack).

In addition, the timeline 300 illustrates several time periods: the validity period 320 extending from the origination 302 to the predetermined VP expiration time 312; the delivery period 322 extending from the origination 302 to the point time 306 that the SMS message 200 is received; and the expiration period 324 extending from the origination 302 to the predetermined TOE expiration time 310. It should be appreciated that the validity period 320 is related to the VP data and the expiration period 324 is related to the TOE data. Further, it should be appreciated that the VP data, the point in time 312 associated with the VP data, and the validity period 320 all may vary in duration and length. Likewise, the TOE data, the point in time 310 associated with the TOE data, and the expiration period 324 all may vary in duration and length.

As will be explained more below, when the SMS message 200 is delivered or received by the terminating mobile device (e.g., the telematics unit 30) prior to the point in time associated with TOE (310) the message 200 may be accepted. And when the SMS message 200 is not delivered or received prior to this point in time (310), the message 200 may be rejected, discarded, or otherwise ignored.

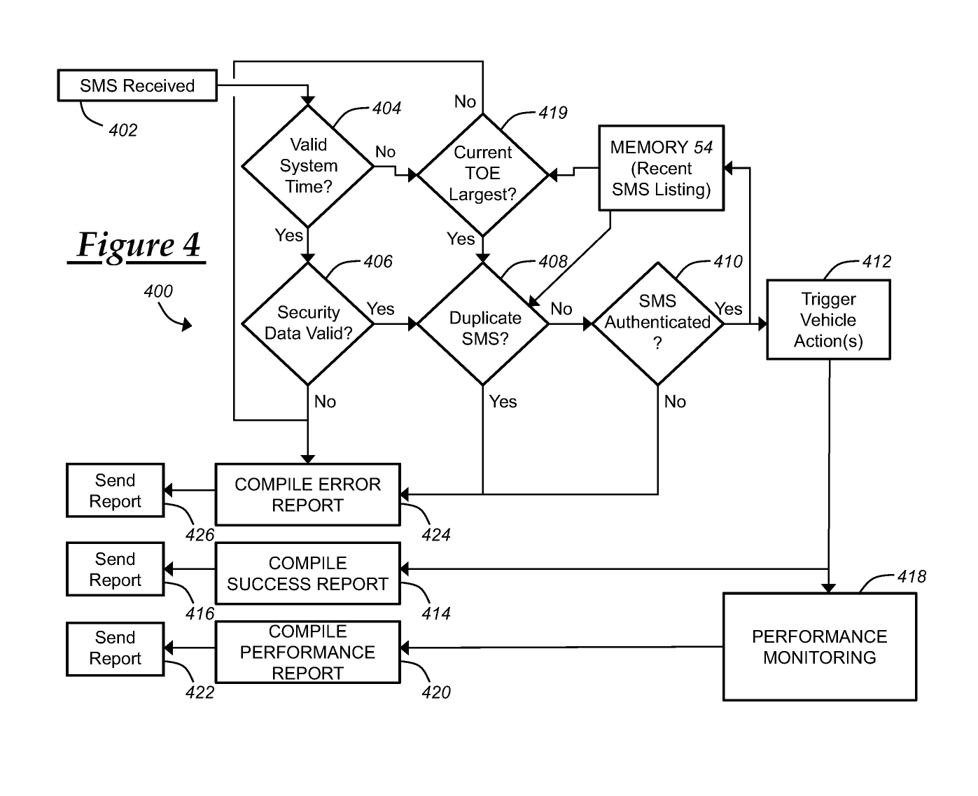

FIG. 4 illustrates one method 400 of processing the SMS message 200. The method 400 begins at step 402 where the vehicle telematics unit 30 receives the SMS message 200 (e.g., corresponding to point in time 306, FIG. 3). Telecommunication of SMS messages is known and will not be described herein. In step 402, the telematics unit 30 also may receive a system time from the timekeeper 57 (shown in FIG. 1); e.g., a timestamp from the timekeeper.

At step 404, the processor 52 of the telematics unit 30 may determine whether the system time is accurate or valid. For example, when the timekeeper 57 is operating properly, the system time may be determined to be valid. Thus, step 404 may include validating the operation of the timekeeper and/or received timestamp. However, when the timekeeper 57 is not operating properly or that the timestamp is inaccurate (e.g., using suitable parameters, vehicle diagnostics, etc.), the system time may not be validated. In step 404, when the system time is determined to be valid, the method 400 proceeds to step 406.

In step 406, the processor 52 of the telematics unit 30 may determine or evaluate whether the SMS message 200 is valid using the security data 232 (carried by the proprietary header 212). In one implementation, the security data 232 includes the TOE data. Thus, the TOE data may be compared with or evaluated using the timekeeper timestamp. If the timekeeper timestamp (e.g., 13:05:00) is greater than (or occurs later than) the TOE data (e.g., 13:00:00), then the message 200 has expired and may be considered invalid. If however the timekeeper timestamp (e.g., 13:05:00) is less than (or occurs earlier than) the TOE data (e.g., 13:15:00), then the message 200 may be considered valid. The example times are merely used for illustration; various other suitable times may be used. And where the message 200 is evaluated as valid, then method 400 may proceed to step 408.

In step 408, the processor 52 may determine or compare the SMS message 200 to previously received SMS messages to determine whether the message 200 is a duplicate or is otherwise the same as a message previously received. The previously received messages may be stored in memory 54 in a recent SMS list or listing. The list may be updated regularly and older previously received SMS messages may be occasionally purged (e.g., daily, weekly, monthly, or accordingly to any suitable determination of what SMS messages may be considered recent). If the SMS message 200 does not match one of the previously received messages in the SMS list, the method 400 may proceed to step 410.

In step 410, the processor 52 may determine or authenticate the SMS message 200; for example, the processor 52 may authenticate the security data 232 using the security data 232′ carried by the payload 204. The processor may decrypt the security data 232′ (e.g., the encrypted TOE data) using a secret key according to a private or public key infrastructure; as previously described with respect to encryption techniques, decryption techniques are similarly familiar to those skilled in the art. Once the security data 232′ is decrypted, the SMS message 200 may be authenticated by comparing the security data 232 of the proprietary header 212 with the decrypted security data 232′; i.e., authentication occurs when the unencrypted TOE data equals the decrypted TOE data. Where the security data 232 is authenticated, the SMS message 200 is considered authentic. Where the security data 232 is not authenticated, the SMS message 200 is considered unauthentic, damaged, incomplete, or even tampered with—thus, the authentication has failed. Other security checks and authentication (and/or encryption) techniques may also be applied in step 410, as will be appreciated by skilled artisans.

After the step 410, the SMS message 200 may be stored in memory 54—now as a previously received message to be compared with future incoming SMS messages. In addition, if the security data 232 is authenticated, the method 400 may proceed to step 412.

In step 412, since the SMS message has been authenticated, the message data 240 may be accepted by the telematics unit 30. Since the message data 240 may include a vehicle command(s), step 412 may include triggering an execution or performance of a remote vehicle action (e.g., locking or unlocking a vehicle door, starting or shutting off a vehicle engine, actuating or de-actuating a vehicle car alarm, just to name a few examples). After step 412, the method 400 may proceed to step 414 and compile a success report.

In step 414, the success report may be an indication of the acceptance and/or successful receipt of the SMS message 200 at the telematics unit 30; e.g., that the message data 240 was accepted and, where applicable, executed. The compilation at step 414 may include one or more SMS messages, and at step 416, the success report may be sent to the call center 20 using the telematics unit 30.

Additionally after step 412, the method 400 may proceed to step 418 for SMS performance monitoring. For example, the performance monitoring may include delay calculations, failure statistics, data aggregation, etc. related to SMS messages. Thereafter, a performance report may be compiled at step 420. The performance report may include data associated with one or more SMS messages, and at step 422, the performance report may be sent to the call center 20 using the telematics unit 30.

Returning to step 404 of FIG. 4, on some occasions, the system time may be determined to be invalid. When the system time of the telematics unit 30 is invalid (i.e., unavailable or inaccurate), the method 400 may proceed to step 419 where the method 400 may determine whether the TOE data of the current SMS message 200 is greater than the TOE data of any of the most recently received messages stored in memory 54. If the current TOE data is greater than these stored TOE data(s), then the method may proceed to step 408 and continue proceeding as described above. Thus, the method 400 includes a secondary or backup means to determine whether the TOE data is valid, even when the timekeeper 57 in the telematics unit 30 is inoperable or otherwise unable to provide an accurate system time. On the other hand, if in step 419 the current TOE data is less than the most recent TOE data stored in memory 54, then the method may proceed to step 424, as described below.

In each of the steps 406, 408, 410, and 419, the SMS message 200 may be rejected. In these circumstances, method 400 proceeds to step 424, compiling an error report. For example, where in step 406 the SMS message 200 is evaluated as invalid (using the TOE data in the proprietary header 212), then method 400 evaluates that the SMS message 200 was received too late (i.e., after the TOE 310), and the error report is compiled in step 424. Or for example, where in step 408 the SMS message 200 does match one of the previously received messages, the method 400 determines that SMS message 200 is a duplicate, and the error report is compiled in step 424. Or for example in step 410, where the decrypted results of security data 232′ does not match security data 232 of the header 212, the method 400 determines that the SMS message 200 has been tampered with or otherwise damaged during transmission, and the error report is compiled in step 424. Or in another example, when the current TOE data of step 419 is less than any of the recently stored TOE data (associated with recent messages stored in memory 54), then the method 400 compiles the error report of step 424.

In step 424, the error report may be an indication of the rejection or failed receipt of the SMS message 200 at the telematics unit 30; e.g., that the message data 240 was not accepted and, where applicable, not executed. The compilation at step 424 may include one or more SMS messages, and at step 426, the error report may be sent to the call center 20 using the telematics unit 30.

Thus there has been described several embodiments for processing an SMS message and determining whether the contents of the message are valid and/or authentic. Thus far, the validity and/or authenticity of the SMS message may be determined using the security data of the proprietary header 212 and message payload 204, as well as other known authentication means. In addition, malicious attacks may be rebuffed using the described encryption techniques of the security data.

In addition to the aforedescribed techniques, in another embodiment, the method(s) may validate that the length of time between various points in time of FIG. 3 occur within a reasonable duration. For example, a duration (FIG. 3, d₁) between the mobile origination point 302 and the SCTS at point 304 may be calculated and evaluated using the processor 52—a mobile-origination timestamp (associated with point 302) may be subtracted from the SCTS (associated with point 304), and the processor may be determine whether the duration (d₁) is reasonable (e.g., below a predetermined threshold). Where the mobile-origination timestamp is unavailable, it may be estimated using the TOE data.

In another example, the delivery period 322 (FIG. 3) may be calculated and evaluated using the processor 52—the mobile-origination timestamp (point 302) may be subtracted from a message received-timestamp (associated with point 306), and the processor may be determine whether the duration of the delivery period 322 is reasonable (e.g., below a predetermined threshold).

In another example, a duration (FIG. 3, d₂) may be calculated and evaluated using the processor 52—the message received-timestamp (associated with point 306) may be subtracted from a message processed-timestamp (associated with point 308), and the processor may be determine whether the duration (d₂) is reasonable (e.g., below a predetermined threshold).

And in another example, a duration (FIG. 3, d₃) may be calculated and evaluated using the processor 52—the mobile-origination timestamp (associated with point 302) may be subtracted from the message-processed timestamp (associated with point 308) and the processor may be determine whether the duration (d₃) is reasonable (e.g., below a predetermined threshold). And again, where the mobile origination timestamp is unavailable, it may be estimated using the TOE data.

In each of these examples, it should be appreciated that timestamps associated with the receiving and processing the SMS message 200 (e.g., associated with points 306, 308) may be timestamps or marks determined and recorded by the telematics unit 30 and stored memory 54.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of processing an SMS message transmitted between a vehicle telematics unit and a call center, comprising the steps of:
(a) receiving an SMS message having security data, wherein both a header and a payload of the SMS message carry the security data;
(b) attempting to authenticate the security data;
(c) accepting the SMS message if the security data is authenticated; and
(d) ignoring the contents of the SMS message if the security data is not authenticated.

2. The method of claim 1, wherein the security data is associated with a time of expiration (TOE) of the SMS message.

3. The method of claim 1, wherein the security data carried by the payload is encrypted.

4. The method of claim 1, wherein the SMS message carries a vehicle command, the method further comprising step (e): executing the vehicle command if the SMS message is authenticated in step (c).

5. The method of claim 1, further comprising receiving a system time from the telematics unit and evaluating the validity of the security data using the system time.

6. The method of claim 5, wherein the evaluating step occurs prior to step (b), wherein if the security data is determined to be invalid the SMS message is ignored and steps (b) and (c) are omitted.

7. The method of claim 1, further comprising, prior to step (b), comparing the SMS message to previously received SMS messages, wherein if the SMS message is the same as one of the previously received SMS messages, the SMS message is ignored and at least the accepting step (c) is omitted.

8. The method of claim 1, further comprising, prior to step (b), comparing the time of expiration of the current SMS message with the time of expirations of other previously received SMS messages, wherein if the time of expiration of the current SMS message is less than any of the time of expirations associated with the previously received SMS messages, the current SMS message is ignored and at least the accepting step (c) is omitted.

9. The method of claim 1, further comprising transmitting an error report to the call center when the SMS message is ignored.

10. The method of claim 1, further comprising transmitting a success report to the call center when the SMS message is accepted.

11. A method of processing an SMS message, comprising the steps of:
(a) receiving at a vehicle telematics unit an SMS message having a vehicle instruction, wherein the SMS message includes security data carried by a header of the SMS message, wherein an encrypted version of the security data is also carried by a payload of the SMS message;
(b) determining whether a telematics unit system time is accurate;
(c) when in step (b) the system time is determined to be accurate, evaluating the validity of the security data using the system time, wherein if security data is evaluated to be invalid, compiling an SMS error report and at least omitting the executing step (g);
(d) determining whether a duplicate of the SMS message was previously received at the telematics unit, wherein if a duplicate was previously received, compiling an SMS error report and at least omitting the executing step (g);
(e) decrypting the encrypted version of the security data;
(f) authenticating the security data carried by the header using the decrypted security data, wherein if the security data carried by the header is not authenticated, compiling an SMS error report and omitting step (g); and
(g) if the security data carried by the header is authenticated, executing the vehicle instruction.
